(19) United States
(12) Patent Application Publication
(10) Pub. No.: US 2021/0197646 A1
(43) Pub. Date: Jul. 1, 2021

(54) MODULAR ROOF-MOUNTED AIR-CONDITIONING SYSTEM

(71) Applicant: MAHLE International GmbH, Stuttgart (DE)

(72) Inventors: Alexander Argento, Ludwigshafen (DE); Christoph Hipp, Stuttgart (DE); Sagar Kantipudi, Stuttgart (DE); Markus Schauer, Marbach (DE); Deepak Sehgal, Stuttgart (DE); Armin Wiestner, Leutenbach (DE)

(21) Appl. No.: 17/204,862

(22) Filed: Mar. 17, 2021

Related U.S. Application Data
(63) Continuation of application No. PCT/EP2019/074887, filed on Sep. 17, 2019.

(30) Foreign Application Priority Data
Sep. 18, 2018 (DE) 10 2018 215 836.3

(51) Int. Cl. B60H 1/00

(52) U.S. Cl. CPC B60H 1/00542; B60H 2001/00235; B60H 1/00207; B60H 1/00535

(57) ABSTRACT

A modular, roof-mounted air-conditioning system for a vehicle includes at least two similar air-conditioning modules for air-conditioning areas within the vehicle, wherein the air-conditioning modules are combined to form a functional assembly, and wherein the assembly can be installed on a roof of the vehicle.

### CROSS REFERENCE TO RELATED APPLICATIONS

This application is a continuation application of international patent application PCT/EP2019/074887, filed Sep. 17, 2019, designating the United States and claiming priority to German application 10 2018 215 836.3, filed Sep. 18, 2018, and the entire content of both applications is incorporated herein by reference.

### TECHNICAL FIELD

The disclosure relates to a modular roof-mounted air-conditioning system for a vehicle.

### BACKGROUND

In contrast to air-conditioning systems for passenger cars, air-conditioning systems for large-capacity vehicles, such as utility vehicles, omnibuses or the like, are typically not arranged within the vehicle, but are typically mounted on a roof of the vehicle. This is because the air-conditioning systems for large-capacity vehicles are used to air-conditioning a larger vehicle area and compared to passenger cars, have to provide a larger cooling capacity. However, a larger cooling capacity is also associated with a larger dimensioning of the air-conditioning system. Air-conditioning systems, which are arranged on a roof of a vehicle, are referred to as roof-mounted air-conditioning systems. A roof-mounted air-conditioning system of this type typically provides a cooling capacity in the range of from 20 kW to approximately 50 kW.

A roof-mounted air-conditioning system includes at least a portion of the refrigerant circuit, in which a refrigerant circulates, at least one evaporator unit for evaporating the refrigerant, at least one condenser unit for liquefying the refrigerant, as well as at least one expansion unit for spraying in the refrigerant, which is still in liquid form. The condenser unit can be equipped with at least one condenser fan, and the evaporator unit can be equipped with at least one evaporator fan.

A roof-mounted air-conditioning system can also include at least one compressor unit for compressing the refrigerant. If said compressor unit is not installed in the roof-mounted air-conditioning system, it is located at another location of the vehicle, for example in the belt drive of the internal combustion engine of the vehicle.

If the refrigeration circuit is operated in a supercritical manner, the gas cooler unit can replace the condenser unit. If the refrigeration circuit is used to convey heat from the external air into the interior, an external heat exchanger unit can replace the condenser unit, so that refrigerant is cooled and optionally condensed or evaporated in said refrigeration circuit, depending on the operating mode.

The components of the roof-mounted air-conditioning system are accommodated in a large common housing, wherein an evaporator unit and a heater unit including, for example, two to four radial fans, are in each case combined in a sub-housing, in particular in a common sub-housing, wherein a further sub-housing can be provided, in which a condenser unit including two to six axial fans is arranged. For example, a sub-housing including evaporator unit is arranged on the left in the driving direction, a second one is arranged on the right, and a sub-housing including the condenser unit is arranged therebetween. In another arrangement, the sub-housing is arranged in the condenser unit upstream of or downstream from the sub-housings including the evaporator units. An evaporator unit and a heater unit can be accommodated together with evaporator fan (embodied as radial fan) in a common sub-housing.

Compared to components of air-conditioning systems for passenger cars, the mentioned components, in particular a common housing, a sub-housing, the evaporator, heater and/or condenser units, of the roof-mounted air-conditioning system are large and the manufacture thereof is rather unwieldy. Due to their size, they are not produced on manufacturing means for air-conditioning systems for passenger cars and/or trucks. For this reason and due to their comparatively small production volume, the manufacturing technologies and materials, which are known from the manufacture of passenger cars and/or trucks, are not used in the manufacture of roof-mounted air-conditioning systems. For example, SMC plastic parts are used instead of injection molded plastic parts, and mechanically joined round-tube evaporators are used instead of disk-type evaporators or flat-tube evaporators in the case of roof-mounted air-conditioning systems.

A problem of the known prior art is that different vehicles also require different cooling capacities and thus different roof-mounted air-conditioning systems. If roof-mounted air-conditioning systems and thus the dimensioning of the components thereof and of the housing are to be tailored exactly to the cooling capacity demand of the vehicles, the manufacturing means have to be selected or adapted as a function of the required cooling capacity of the roof-mounted air-conditioning system. It can in particular be required that the size of components, such as evaporator, heater, and condenser are adapted to the performance demand.

It is known from the prior art that several identical roof-mounted air-conditioning systems can be mounted on the roof so as to be distributed over the length of the vehicle for vehicles including a reduced cooling capacity demand, which is less than 20 kW, wherein each of these systems has an electrically driven refrigerant compressor, and wherein each of these systems provides a cooling capacity of, for example, maximally 4 kW. Due to the low cooling capacity of the individual roof-mounted air-conditioning system, a very large number of individual roof-mounted air-conditioning systems of this type is required for assembling a roof-mounted air-conditioning system with a cooling capacity of at least 20 kW, which need to be mounted individually in the vehicle. This is not acceptable from a cost-related aspect.

### SUMMARY

It is an object of the present disclosure to provide a roof-mounted air-conditioning system of the above-mentioned type, which can be produced and operated more cost-efficiently.

The object is achieved by a modular roof-mounted air-conditioning system for a vehicle as described herein.

The present disclosure is based on the general idea that in the case of the manufacture of the roof-mounted air-conditioning system or of the components thereof, respectively, large batch technologies from the manufacture for passenger cars and/or trucks can be used in order to provide a more cost-efficient production with a maximum application flexibility.

The roof-mounted air-conditioning system according to the disclosure for a vehicle is formed as modular roof-mounted air-conditioning system, which has at least two similar air-conditioning system modules for air-conditioning spatial areas within the vehicle, wherein the air-conditioning system modules are combined to form a functional assembly, wherein the assembly can be installed on a roof of the vehicle.

The similar air-conditioning system modules can be formed separately from one another.

A vehicle can be a large-capacity vehicle, such as, for example, a utility vehicle, an omnibus, or the like. A vehicle can in particular be a rail less vehicle.

Spatial areas can be, for example, sub-areas of the vehicle cabin. Sub-areas of the vehicle cabin can be, for example, a driver's cockpit, a front and/or rear part of the passenger compartment. Sub-areas of the vehicle cabin can be, for example, adjoining areas, in particular a driver resting area and/or a cargo area.

Spatial areas can be sub-areas within the vehicle, in which vehicle components and/or vehicle aggregates can be arranged. Vehicle components can be, for example, electronic units, electric motors and/or batteries.

Spatial areas can be vehicle components and/or vehicle aggregates of the vehicle. Vehicle components can be, for example, electronic units, electric motors and/or batteries.

Spatial areas can be all aggregates of the vehicle, which have to be cooled or which have to absorb heat in order to heat the vehicle interior.

Auxiliary functions can be formed, so that a temperature control of vehicle components, in particular of electronic units, electric motors and/or batteries is provided. A temperature control of vehicle components, in particular of electronic units, electric motors and/or batteries can be provided in particular with the roof-mounted air-conditioning system.

At least two similar air-conditioning system modules do not have be formed identically.

At least two air-conditioning system modules can be considered to be similar if they each have a cooling system, or parts of a cooling system, or parts of several cooling systems. At least two similar air-conditioning system modules can each have a cooling system, or parts of a cooling system, or parts of several cooling systems.

At least two air-conditioning system modules can be considered to be similar if they each have a unit for exchanging heat with the vehicle environment, and a unit for exchanging heat with the vehicle (e.g., with a cabin and/or other spatial areas and/or components of the vehicle). At least two similar air-conditioning system modules can each have a unit for exchanging heat with the vehicle environment, and a unit for exchanging heat with the vehicle (e.g., with a cabin and/or other spatial areas and/or components of the vehicle).

At least two air-conditioning system modules can be considered to be similar if the arrangement of these units and/or air-conditioning system modules relative to one another is identical, or if the arrangement of these units and/or air-conditioning system modules relative to one another is approximately or essentially mirrored and/or mirror-symmetrically with respect to a plane. At least two similar air-conditioning system modules can be arranged identically relative to one another. At least two similar air-conditioning system modules can be arranged relative to one another in an approximately or essentially mirrored and/or mirror-symmetrical manner with respect to a plane.

At least two air-conditioning system modules can be considered to be similar if the structural embodiment of the air-conditioning system modules and/or the used materials are predominantly identical and/or essentially similar (e.g., plastic injection molding housing and frame parts, aluminum pipes, aluminum heat exchangers, hoods made of thermally deformable plastic films). At least two similar air-conditioning system modules can have predominantly identical and/or essentially similar structural embodiments and/or used materials (e.g., plastic injection molding housing and frame parts, aluminum pipes, aluminum heat exchangers, hoods made of thermally deformable plastic films).

At least two air-conditioning system modules can be considered to be similar if instead of cabin air, only coolant for cooling a vehicle component, e.g., a battery, could also be used exclusively, so that for example all evaporators could be replaced by chillers. Primary differences between two or more similar air-conditioning system modules can (can be possible, but are not mandatorily), for example, be the number and type of the components for the respective required functional equipment.

In the case of two or more similar air-conditioning system modules, a first air-conditioning system module can have an evaporator (refrigerant-air heat exchanger) for cooling air, whereas a second air-conditioning system module can have a chiller (refrigerant-coolant liquid heat exchanger) for cooling vehicle aggregates, such as, for example, batteries or electronic systems, or for connecting a secondary air conditioner, such as, for example, for a driver's cockpit for cooling purposes with a cooling element (coolant-air heat exchanger).

In the case of two or more similar air-conditioning system modules, a first air-conditioning system module can have an evaporator, whereas a second air-conditioning system module can additionally have a chiller.

In the case of two or more similar air-conditioning system modules, a first air-conditioning system module can have a separate compressor, whereas all other air-conditioning system modules can be centrally and/or jointly connected to a compressor at the vehicle engine.

In the case of two or more similar air-conditioning system modules, at least one air-conditioning system module can have an indirect condenser (refrigerant-coolant liquid heat exchanger) for releasing heat to a coolant liquid/liquid heat exchanger.

In the case of two or more similar air-conditioning system modules, at least one first air-conditioning system module can have an electronic control device, whereas a further air-conditioning system module can have no control device.

In the case of two or more similar air-conditioning system modules, at least one first air-conditioning system module can have an electronic control device, whereas a further air-conditioning system module can be formed to be free from control devices.

In the case of two or more similar air-conditioning system modules, the air-conditioning system modules can each have a module hood, the size and/or shape of which differs in the case of at least two air-conditioning system modules. For example, a modular roof-mounted air-conditioning system can consist of three air-conditioning system modules, or can have three air-conditioning system modules, wherein two air-conditioning system modules are arranged located opposite one another as pair on the roof, and one air-conditioning system module can be arranged so as to be rotated by 90 degrees in the middle between the left and the right roof boundary. The air-conditioning system module arranged in the middle can have a different hood shape than the air-conditioning system module pair.

The air-conditioning system modules can be combined to form a functional assembly, in that they are mechanically connected to one another. A releasable mechanical connection can be provided between the individual air-conditioning system modules as well as between an air-conditioning system module and the modular roof-mounted air-conditioning system.

The air-conditioning system modules can be combined to form a functional assembly, in that they are mechanically connected directly to one another, in order to form a mechanically stable connection and/or mechanically resistant connection and/or shear-resistant connection and/or rotationally fixed connection and/or rigid connection. For this purpose, two or more air-conditioning system modules can, for example, be screwed to one another.

The air-conditioning system modules can be combined to form a functional assembly, in that they are fluidically connected to one another with refrigerant lines and/or coolant lines.

The air-conditioning system modules can be combined to form a functional assembly, in that they are connected to one another with electrical lines.

In an embodiment A, at least two air-conditioning system modules can be connected to one another, for example screwed to one another, in a mechanically stable manner to form a structural unit.

In an embodiment B, it can be provided that even though at least two air-conditioning system modules do not form a mechanically stable structural unit, at least these two air-conditioning system modules can be connected to one another with lines for refrigerants and/or coolants, and can thus be functionally combined. The air-conditioning system modules can be fastened to the vehicle roof individually or in a pre-assembled manner with the help of a mounting aid.

In an embodiment C, it can be provided that at least two air-conditioning system modules are part of a common regulating system for regulating the operation of the modular roof-mounted air-conditioning system.

The embodiments A, B, and C can be at least partially combined with one another.

The embodiments A and B can in particular be relevant and/or advantageous when the roof-mounted air-conditioning system is connected to a central compressor.

The embodiment C can be relevant and/or advantageous when each air-conditioning system module is equipped with a separate compressor and thus represents a separate refrigerating machine.

At least two air-conditioning system modules can be mounted on the roof located opposite one another relative to a vehicle center line, whereby they are arranged approximately at the same position in the longitudinal direction of the vehicle.

At least two air-conditioning system modules can be mounted on the roof located opposite one another with respect to a vehicle center line, whereby they are arranged essentially at the same position with respect to the longitudinal direction of the vehicle. The two air-conditioning system modules can thereby be arranged essentially mirror-symmetrically with respect to the vehicle center line. The vehicle center line can thereby run between the at least two air-conditioning system modules.

In its totality, the assembly can be mounted on the roof of the vehicle or can also be removed from the roof again in its entirety, when this is necessary, for example during maintenance work. Mounting aids can be required or can be used for this purpose when the air-conditioning system modules are not connected to one another in a sufficiently stable manner and thus have to be protected individually. Due to the fact that not every air-conditioning system module has to be mounted individually on the roof of the vehicle, the number of the required work steps for the installation of a modular roof-mounted air-conditioning system according to the disclosure can be reduced.

If necessary, every air-conditioning system module can also be mounted on the roof or can be removed from the roof individually. This is an advantageous simplification in particular during maintenance because smaller structural units have to be moved.

Depending on the demand for the cooling capacity of the vehicle, the number of the air-conditioning system modules can be selected appropriately, whereby additional design work with respect to the components is minimized.

An air-conditioning system module can have a cooling capacity of at least 8 kW to 15 kW, or 8 kW to 16 kW, whereby the modular roof-mounted air-conditioning system can have a cooling capacity of at least 20 kW.

Roof-mounted air-conditioning systems, which have a cooling capacity of at least 8 kW to approximately 15 kW, are typically used in minibuses with approximately up to 22 seats. A roof-mounted air-conditioning system of this type for minibuses is known from DE 10 2015 211 594 A1.

The air-conditioning system modules can have separate housings, whereby it is also conceivable that the modular roof-mounted air-conditioning system has a common housing. A common housing, a housing, or a sub-housing can enclose components of the roof-mounted air-conditioning system and can comprise several housing parts. A common housing, a housing, or a sub-housing can also be formed as hood, which at least partially covers the components of the roof-mounted air-conditioning system, wherein the hood can preferably be formed as visible part of the roof-mounted air-conditioning system. It can be provided that a hood of this type covers and/or covers up the area between roof-mounted air-conditioning system and environment of the vehicle.

If a hood has the function of a cover, thus closing, among other things, it can also be an upper housing part. If a hood does not close anything and only covers, it cannot be a housing part, but a covering with protective function and/or with optical function.

The air-conditioning system modules can additionally be covered with separate hoods, whereby it is also conceivable that a large hood covers the entire modular roof-mounted air-conditioning system, or several hoods cover only parts of the roof-mounted air-conditioning system, e.g., a left and a right hood cover the parts of the roof-mounted air-conditioning system located on the roof on the outside.

The modular roof-mounted air-conditioning system can have a control means, whereby it is also conceivable that at least one air-conditioning system module has a control means. A control means of this type can be connected in a communicating manner to components of the modular roof-mounted air-conditioning system and/or with air-conditioning system modules and/or with components of the air-conditioning system modules.

A communicating connection indicates that a bidirectional or unidirectional data connection, with which electrical control, regulating and/or measuring signals can be transferred in analog or digital form, can be provided between two components, which are connected in a communicating manner to one another. The communication between more than two components can be realized with a bus system.

In the case of a further advantageous embodiment of the solution according to the disclosure, it is provided that at least one air-conditioning system module has at least one evaporator unit for evaporating a refrigerant, at least one condenser unit for liquefying a refrigerant, at least one evaporator fan, and at least one condenser fan. The condenser fan ensures a sufficient recirculation ventilation of the condenser unit, and the evaporator fan ensures a sufficient recirculation ventilation of the evaporator unit. The evaporator unit can in particular be a chiller unit. A refrigerant can be evaporated in the chiller unit.

If the refrigeration circuit is operated in a supercritical manner, a gas cooler unit can replace the condenser unit. If the refrigeration circuit is used to convey heat from the external air into the interior, an external heat exchanger unit can replace the condenser unit, so that refrigerant is cooled and optionally condensed or evaporated in said refrigeration circuit, depending on the operating mode. In the operating mode “heat”, the external heat exchanger can release heat to the refrigeration circuit via a chiller, and in the operating mode “cool”, it can absorb heat from an indirect condenser. Chiller and indirect condenser can be arranged at various location/in various submodules and expansion modules.

The components of the air-conditioning system modules can be arranged in different ways. For example, a condenser unit and at least one condenser fan can be arranged upstream of two evaporator units including at least one evaporator fan in the driving direction. It is also conceivable that the condenser unit is arranged downstream from the evaporator unit in the driving direction. In the case of a further arrangement, a condenser unit and a condenser fan can be located between two evaporator units, which each comprise at least one evaporator fan. Other arrangements are likewise possible. For example, two evaporator units, which each comprise at least one evaporator fan, can be arranged on one side of a condenser unit including at least one condenser fan, viewed in the driving direction.

The evaporator unit and the condenser unit can be arranged in a refrigerant circuit. The evaporator unit can have an evaporator, which is formed as disk-type or flat tube evaporator.

The refrigerant circuit can have at least one expansion unit for spraying in the refrigerant, which is still in liquid form, and at least one conveying means for driving the refrigerant in the refrigerant circuit.

The air-conditioning system module can have at least one chiller unit and at least one condenser unit and at least one condenser fan.

The air-conditioning system module can have at least one chiller unit and at least one gas cooler unit and at least one gas cooler fan.

The air-conditioning system module can have at least one chiller unit and at least one external heat exchanger unit and at least one external heat exchanger fan.

The air-conditioning system module can have at least one evaporator unit including at least one evaporator fan and at least one gas cooler unit and at least one gas cooler fan.

The air-conditioning system module can have at least one evaporator unit including at least one evaporator fan and at least one external heat exchanger unit and at least one external heat exchanger fan.

The air-conditioning system module can have at least one cooling element unit including at least one cooling element fan and at least one external heat exchanger unit and at least one external heat exchanger fan.

The chiller unit can be used to cool the battery.

The chiller unit cannot only be used to cool the battery, but can also be used for other cooling tasks, such as, for example to cool the cabin air at a driver's seat with a cooling element, through which coolant flows, in the driver's seat air conditioner, or to feed heat from coolant circuits to aggregates in the vehicle in terms of heating the cabin air with the roof air-conditioning system in the heat pump mode.

In the case of an advantageous further development of the solution according to the disclosure, it is provided that at least one air-conditioning system module has at least one compressor unit for compressing the refrigerant and/or at least one chiller unit and/or at least one heater unit for heating the air flowing into the vehicle. The chiller unit can be used to cool a coolant, which is used in a cooling circuit to regulate the temperature of a battery unit of the vehicle.

The use of a compressor unit including an electrically driven compressor in each individual air-conditioning system module provides for a redundant design of the modular roof-mounted air-conditioning system, so that the modular roof-mounted air-conditioning system can provide the required cooling capacity even when a single compressor fails.

In combination with combustible refrigerants (e.g., R1234yf and R290), all refrigerant lines can be arranged outside vehicle, namely in this way: In the case of a module including a separate (electrical) compressor and chiller unit, all refrigerant lines are located within the module and thus on the roof. Only coolant lines and no refrigerant lines run from the chiller unit through the interior of the vehicle on the way from and to the front box (driver's seat air conditioner), in order to absorb heat in the front box at a cooling element (air-coolant heat exchanger instead of an evaporator) and to transport it to the roof air-conditioning system.

A heater unit can be a coolant-air heat exchanger, through which warm coolant flows for heating purposes. An electrical water pump for the coolant can additionally be formed thereby.

A heater unit can be an electrical air heater for directly heating ambient air, in particular an air heater including PTC ceramic elements. An electrical water pump for the coolant can additionally be formed thereby.

A heater unit can be a coolant-air heat exchanger in combination with an electrical coolant heater. An electrical water pump for the coolant can additionally be formed thereby.

In the case of a further advantageous embodiment of the solution according to the disclosure, it is provided that at least two air-conditioning system modules are fluidically connected to at least one common compressor unit. If the vehicle has one or several compressor units, the refrigerant can be distributed over the air-conditioning system modules and can be brought together in the return flow. The distribution and collection lines necessary for this purpose can be part of the modular roof-mounted air-conditioning system and/or also of the vehicle.

The disclosure further relates to a modular roof-mounted air-conditioning system for a vehicle, including at least two similar air-conditioning system modules for air-conditioning spatial areas within the vehicle, wherein at least one air-conditioning system module has at least one first submodule and at least one second submodule.

The first submodule has at least one first connecting section, wherein the second submodule has at least one second connecting section. The first submodule and the second submodule can be connected via the first connecting section and the second connecting section. The connection between the first submodule and the second submodule can be designed in a releasable manner.

At least one submodule can thereby have a condenser unit including at least one condenser fan and a case (=housing, which does not completely enclose the components). Another submodule can have one or two evaporator units, which each include an evaporator fan and/or a case. The housings of both submodules can be placed onto a frame, but whereby they are connected to said frame, but not directly to one another. The submodules can be connected, for example, only via refrigerant lines and optionally cable harnesses. It can further be provided that the two submodules overlap in the vertical direction. The vertical direction can be parallel to the surface normal vector of a roof of a vehicle. The first (condenser) submodule can project beyond the second (evaporator) submodule.

At least two submodules can be connected to one another directly in a mechanically stable manner via the connecting sections.

At least two submodules can be connected to one another indirectly in a mechanically stable manner via the connecting sections, wherein the two submodules are connected to one another directly via refrigerant and/or coolant lines as well as electrical lines, while the mechanical stability is attained in that each submodule is connected to a common module frame, which is connected to the roof of the vehicle.

The two last-mentioned connecting options (indirect and direct mechanical connection) of the submodules can also be combined. For example, an overlapping first submodule can thus be screwed to a second submodule located locally there below in the area of the overlap.

A vehicle can be a large-capacity vehicle, such as, for example, a utility vehicle, an omnibus, or the like. A vehicle can in particular be a rail less vehicle.

Spatial areas can be, for example, sub-areas of the vehicle cabin. Sub-areas of the vehicle cabin can be, for example, a driver's cockpit, a front and/or rear part of the passenger compartment. Sub-areas of the vehicle cabin can be, for example, adjoining areas, in particular a driver resting area and/or a cargo area.

Spatial areas can be sub-areas within the vehicle, in which vehicle components and/or vehicle aggregates can be arranged. Vehicle components can be, for example, electronic units, electric motors and/or batteries.

Spatial areas can be vehicle components and/or vehicle aggregates of the vehicle. Vehicle components can be, for example, electronic units, electric motors and/or batteries.

Spatial areas can be all aggregates of the vehicle, which have to be cooled or which have to absorb heat in order to heat the vehicle interior.

Auxiliary functions can be formed, so that a temperature control of vehicle components, in particular of electronic units, electric motors and/or batteries is provided. A temperature control of vehicle components, in particular of electronic units, electric motors and/or batteries can be provided with the roof-mounted air-conditioning system.

The air-conditioning system module can have at least two similar air-conditioning system modules.

The similar air-conditioning system modules can be formed separately from one another.

At least two similar air-conditioning system modules do not have to be formed identically.

At least two air-conditioning system modules can be considered to be similar if they each have a cooling system, or parts of a cooling system, or parts of several cooling systems. At least two similar air-conditioning system modules can each have a cooling system, or parts of a cooling system, or parts of several cooling systems.

At least two air-conditioning system modules can be considered to be similar if they each have a unit for exchanging heat with the vehicle environment, and a unit for exchanging heat with the vehicle (e.g., with a cabin and/or other spatial areas and/or components of the vehicle). At least two similar air-conditioning system modules can each have a unit for exchanging heat with the vehicle environment, and a unit for exchanging heat with the vehicle (e.g., with a cabin and/or other spatial areas and/or components of the vehicle).

At least two air-conditioning system modules can be considered to be similar if the arrangement of these units and/or air-conditioning system modules relative to one another is identical, or if the arrangement of these units and/or air-conditioning system modules relative to one another is approximately or essentially mirrored and/or mirror-symmetrically with respect to a plane. At least two similar air-conditioning system modules can be arranged identically relative to one another. At least two similar air-conditioning system modules can be arranged relative to one another in an approximately or essentially mirrored and/or mirror-symmetrical manner with respect to a plane.

At least two air-conditioning system modules can be considered to be similar if the structural embodiment of the air-conditioning system modules and/or the used materials are predominantly identical and/or essentially similar (e.g., plastic injection molding housing and frame parts, aluminum pipes, aluminum heat exchangers, hoods made of thermally deformable plastic films). At least two similar air-conditioning system modules can have predominantly identical and/or essentially similar structural embodiment and/or used materials (e.g., plastic injection molding housing and frame parts, aluminum pipes, aluminum heat exchangers, hoods made of thermally deformable plastic films).

At least two air-conditioning system modules can be considered to be similar if instead of cabin air, only coolant for cooling a vehicle component, such as, e.g., a battery, could also be used exclusively, so that for example all evaporators could be replaced by chillers. Primary differences between two or more similar air-conditioning system modules can (can be possible, but are not mandatorily), for example, be the number and type of the components for the respective required functional equipment.

In the case of two or more similar air-conditioning system modules, a first air-conditioning system module can have an evaporator (refrigerant-air heat exchanger) for cooling air, whereas a second air-conditioning system module can have a chiller (refrigerant-coolant liquid heat exchanger) for cooling vehicle aggregates, such as, for example, batteries or electronic systems, or for connecting a secondary air conditioner, such as, for example, for a driver's cockpit for cooling purposes with a cooling element (coolant-air heat exchanger).

In the case of two or more similar air-conditioning system modules, a first air-conditioning system module can have an evaporator, whereas a second air-conditioning system module can additionally have a chiller.

In the case of two or more similar air-conditioning system modules, a first air-conditioning system module can have a separate compressor, whereas all other air-conditioning system modules can be centrally and/or jointly connected to a compressor at the vehicle engine.

In the case of two or more similar air-conditioning system modules, at least one air-conditioning system module can have an indirect condenser (refrigerant-coolant liquid heat exchanger) for releasing heat to a coolant liquid/liquid heat exchanger.

In the case of two or more similar air-conditioning system modules, at least one first air-conditioning system module can have an electronic control device, whereas a further air-conditioning system module can have no control device.

In the case of two or more similar air-conditioning system modules, at least one first air-conditioning system module can have an electronic control device, whereas a further air-conditioning system module can be formed to be free from control devices.

In the case of two or more similar air-conditioning system modules, the air-conditioning system modules can each have a module hood, the size and/or shape of which differs in the case of at least two air-conditioning system modules. For example, a modular roof-mounted air-conditioning system can consist of three air-conditioning system modules, or can have three air-conditioning system modules, wherein two air-conditioning system modules are arranged located opposite one another as pair on the roof, and one air-conditioning system module can be arranged so as to be rotated by 90 degrees in the middle between the left and the right roof boundary. The air-conditioning system module arranged in the middle can have a different hood shape than the air-conditioning system module pair.

It can be provided that a fluidic connection for forming a refrigerant circuit can be established via the first connecting section and the second connection section between the first submodule and the second submodule. It can be provided that an electrically conductive connection for the energy supply of the components of the submodules can be established via the first connecting section and the second connecting section between the first submodule and the second submodule. It can be provided that a communicating connection for controlling the submodules and/or the components thereof can be established via the first connecting section and the second connecting section between the first submodule and the second submodule. The submodules can thus be assembled to form an air-conditioning system module, wherein an air-conditioning system module can be assembled in a simple and cost-efficient manner from a plurality of submodules.

The first submodule is formed for exchanging heat energy between the air-conditioning system module and an external environment of the vehicle, wherein the second submodule is formed for exchanging heat energy between the air-conditioning system module and a spatial area, in particular a passenger compartment and/or a driver/front seat area and/or a resting area and/or a refrigerator module and/or a battery unit of the vehicle.

The modular roof-mounted air-conditioning system can include at least one refrigerant circuit, in which a refrigerant circulates, at least one evaporator unit for evaporating the refrigerant, at least one condenser unit for liquefying the refrigerant, at least one compressor unit for compressing the refrigerant, at least one expansion unit for spraying in the refrigerant, which is still in liquid form. The condenser unit can be equipped with at least one condenser fan, and the evaporator unit can be equipped with at least one evaporator fan.

The modular roof-mounted air-conditioning system can have at least one refrigerant circuit, in which a refrigerant circulates, at least one evaporator unit for evaporating the refrigerant, at least one condenser unit for liquefying the refrigerant, at least one compressor unit for compressing the refrigerant, at least one expansion unit for spraying in the refrigerant, which is still in liquid form, and at least one conveying means for driving a coolant in a coolant circuit. The condenser unit can be equipped with at least one condenser fan, and the evaporator unit can be equipped with at least one evaporator fan.

The conveying means for driving a coolant in the coolant circuit can be, for example, a liquid pump, in particular a water pump.

The modular roof-mounted air-conditioning system can have at least one refrigerant circuit, in which a refrigerant circulates, at least one evaporator unit for evaporating the refrigerant, at least one condenser unit for liquefying the refrigerant, at least one compressor unit for compressing the refrigerant, at least one expansion unit for spraying in the refrigerant, which is still in liquid form, and at least one conveying means for driving the refrigerant in the refrigerant circuit. The condenser unit can be equipped with a condenser fan, and the evaporator unit can be equipped with an evaporator fan.

The submodules can have a housing, which can be formed for holding components of the respective submodule and/or for the flow guidance of the ambient air to the submodule and/or away from the submodule.

The housing can be open at locations, at which adjoining air-conditioning system modules form wall surfaces for guiding the air.

The modular roof-mounted air-conditioning system can have a control means, whereby it is also conceivable that at least one air-conditioning system module and/or a submodule has a control means. A control means of this type can be connected in a communicating manner to components of the modular roof-mounted air-conditioning system and/or with air-conditioning system modules and/or with components of the air-conditioning system modules and/or with submodules.

An air-conditioning system module can have a cooling capacity of at least 8 kW to 15 kW, or 8 kW to 16 kW, whereby the modular roof-mounted air-conditioning system can have a cooling capacity of at least 20 kW. The air-conditioning system modules can be combined to form a functional assembly, wherein the assembly can be capable of being installed on a roof of the vehicle.

Different, individually tailored product solutions are used in the prior art, which lead to a large variety of parts, the product portfolio can thus only be expanded with a comparatively high effort. The modular roof-mounted air-conditioning system according to the disclosure, in contrast, can manage with a few types of submodules, so that roof-mounted air-conditioning systems of various length, width, capacity, and features can be provided for vehicles of various sizes and with different roof shapes, in particular for minibuses and large busses.

In the case of an advantageous further development of the solution according to the disclosure, it is provided that the first submodule has at least one first heat exchanger unit for exchanging heat energy between the air-conditioning system module and the external environment of the vehicle, wherein the second submodule has at least one second heat exchanger unit for exchanging heat energy between the air-conditioning system module and the spatial area, in particular a passenger compartment and/or a driver/front seat area and/or a resting area and/or a refrigerator module and/or a battery unit of the vehicle, wherein the second submodule has at least one fan unit. It is conceivable that the first submodule also has at least one fan unit.

In the case of a further advantageous embodiment of the solution according to the disclosure, it is provided that the first submodule has at least one compressor unit. It is also conceivable that the first submodule is fluidically connected to a compressor unit of the vehicle.

In the case of an advantageous further development of the solution according to the disclosure, it is provided that the second submodule has at least one heater unit for heating the air flowing into the vehicle and/or at least one air filter unit for filtering the air flowing into the vehicle and/or at least one chiller unit. The chiller unit can be used to cool a coolant, which is used in a cooling circuit to regulate the temperature of a battery unit of the vehicle.

The chiller unit cannot only be used to cool the battery, but can also be used for other cooling tasks, such as, for example to cool the cabin air at a driver's seat with a cooling element, through which coolant flows, in the driver's seat air conditioner, or to feed heat from coolant circuits to aggregates in the vehicle in terms of heating the cabin air with the roof air-conditioning system in the heat pump mode.

In the case of a further advantageous embodiment of the solution according to the disclosure, it is provided that a submodule has a housing, wherein the design of the housing is formed to be at least partially complementary to the roof area of the vehicle, at which the submodule is arranged. If the housing forms a bottom area, the bottom area of the housing can take into account the roof curvatures in the transverse and driving direction of the vehicle. The modular roof-mounted air-conditioning system can thereby be adapted to every roof geometry of a vehicle. For this purpose, a flexible and/or elastic and/or elastically deformable housing bottom can be provided, which adapts and/or clings to every roof contour.

In the case of an advantageous further development of the solution according to the disclosure, it is provided that at least one first air-conditioning system module air-conditions a first subarea of the vehicle, wherein at least one second air-conditioning system module air-conditions a second subarea of the vehicle. The vehicle can be divided into a plurality of subareas, wherein each subarea for air-conditioning can in each case be assigned to one air-conditioning system module. An air-conditioning system module can be used, for example, for dissipating the heat of a driver's seat air conditioner, wherein another air-conditioning system module is used to dissipate the heat from the passenger compartment.

Subareas of the vehicle can also be spatial areas of the vehicle.

Subareas can be, for example, subareas of the passenger compartment and/or the driver's cockpit and/or each individual component, for which the air-conditioning system takes over the thermal management.

In the case of the known prior art, the entire roof-mounted air-conditioning system has to be turned on or turned off. This embodiment of the modular roof-mounted air-conditioning system according to the disclosure is advantageous in such a way that only the air-conditioning system modules, which are responsible for the respective subarea of the vehicle, have to be operated during the operation of the modular roof-mounted air-conditioning system. If no air conditioning is required in a subarea, the responsible air-conditioning system can be turned off and thus leads to energy savings. It is a further advantage that only one air-conditioning system module with a corresponding functionality has to be installed or replaced, respectively, in response to an upgrading or retrofitting, respectively, of the modular roof-mounted air-conditioning system.

In the case of a further advantageous embodiment of the solution according to the disclosure, it is provided that a subarea of the vehicle includes a cooling or a temperature-controlling of a battery unit of the vehicle. In that case, the responsible air-conditioning system module can have an additional chiller, in order to cool a coolant of a battery unit. It can also be provided that the battery unit and/or other spatial areas and/or other subareas are temperature-controlled.

The chiller unit cannot only be used to cool the battery, but can also be used for other cooling tasks, such as, for example to cool the cabin air at a driver's seat with a cooling element, through which coolant flows, in the driver's seat air conditioner, or to feed heat from coolant circuits to aggregates in the vehicle in terms of heating the cabin air with the roof air-conditioning system in the heat pump mode.

In the case of an advantageous further development of the solution according to the disclosure, it is provided that at least one frame unit is arranged between the modular roof-mounted air-conditioning system and the roof of the vehicle. The frame unit can have one or several frames, which are connected to the vehicle roof. The frame unit can also be adhered to the vehicle roof. It can be provided thereby that the air-conditioning system modules are fastened to the frame unit in a quickly releasable and mountable manner. For example, quick releases or equivalent screws or pins can be used for this purpose.

The frame unit can be formed as sealing frame. This sealing frame can abut between system/module and roof, as in the case of a sandwich and can, for example, seal the system/module to the roof.

Individual air-conditioning system modules or the entire modular roof-mounted air-conditioning system can thereby be replaced quickly during maintenance, so that the roof-mounted air-conditioning system does not need to be maintained or repaired on the roof. The downtime of the vehicle thus decreases.

In the case of a further advantageous embodiment of the solution according to the disclosure, it is provided that at least one module frame unit is arranged between at least one air-conditioning system module and the roof of the vehicle. The module frame unit can have one or several frames, which are connected to the frame unit or directly to the vehicle roof. The module frame unit can also be adhered to the vehicle roof. It can be provided thereby that an air-conditioning system module is fastened to the module frame unit in a quickly releasable and mountable manner. For example, quick releases or equivalent screws or pins can be used for this purpose. The module frame unit can be adapted to a geometry of the roof of the vehicle, whereby it can also be provided that the module frame unit is formed to be at least partially complementary to the geometry of the roof. A flexible and/or elastic and/or elastically deformable housing bottom, which adapts and/or clings to every roof contour, can be provided for this purpose.

In the case of an advantageous further development of the solution according to the disclosure, it is provided that the modular roof-mounted air-conditioning system has a common housing and/or at least one air-conditioning system module has a sub-housing, in order to provide protection against atmospheric influences.

Housings can also be formed as hoods. They can be hoods, which cover the entire air-conditioning system and/or can be hoods, which cover subareas of several modules (e.g., all second submodules as well as all expansion modules) and/or can be hoods, which cover subareas of at least one module, e.g., the second submodule.

In the case of a further advantageous embodiment of the solution according to the disclosure, it is provided that at least one electrically controllable expansion valve is provided, wherein the expansion valve is connected in a communicating manner to a control means, wherein the control means is set up and/or programmed to control and/or regulate the expansion valve.

Thermostatic expansion valves are typically used in the prior art. Cooling systems for vehicles often have two to four evaporators, which are connected in parallel, in a cooling circuit. The individual evaporators can be equipped with shut-off valves. All evaporators in each case have a thermostatic expansion valve or a fixed throttle. The problem of this is that the more evaporators are operated in a cooling system in a very large operating range, as is typical in automotive applications, the higher the risk that the cooling system assumes a state, in which one or several thermostatic expansion valves deactivate the refrigerant flow to the evaporator thereof such that it gets warm. The embodiment according to the disclosure of the modular roof-mounted air-conditioning system solves this problem in that the expansion valves are regulated via the control means such that an unintentional closing to an evaporator is prevented. All evaporators thus cool evenly, even if difficult ambient conditions are present.

In the case of a further advantageous embodiment of the solution according to the disclosure, it is provided that the modular roof-mounted air-conditioning system and/or an air-conditioning system module have an electrically controllable expansion valve or several electrically controllable expansion valves, and/or that an expansion valve of this type is assigned to each evaporator unit of the modular roof-mounted air-conditioning system.

In the case of a further advantageous embodiment of the solution according to the disclosure, it is provided that in the case of at least two air-conditioning system modules, refrigerant-air heat exchangers, in particular all refrigerant-air heat exchangers, are formed as soldered aluminum-microchannel heat exchangers, in particular as flat-tube heat exchangers and/or that at least one refrigerant-coolant heat exchanger and/or at least one chiller is formed as soldered stacked plate heat exchanger, in particular as soldered all-aluminum stacked plate heat exchanger.

A soldered stacked plate heat exchanger, in particular as soldered all-aluminum stacked plate heat exchanger, provides for an advantageous weight savings.

In the case of a further advantageous embodiment of the solution according to the disclosure, it is provided that at least one air-conditioning system module can be mounted on the roof, in particular flexibly mounted, such that a center line of the air-conditioning system module is aligned either perpendicular to the vehicle center line or parallel to the vehicle center line, and/or that every air-conditioning system module has a control means, which are connected in a communicating manner to one another, or that a central control means for all air-conditioning system modules is formed. For optical and/or aerodynamic reasons, air-conditioning system modules, which are aligned differently with respect to the vehicle center line, can have different hoods.

In the case of a further advantageous embodiment of the solution according to the disclosure, it is provided that at least two similar air-conditioning system modules are mounted to common frames, in particular a common frame unit, and are mechanically connected thereto, wherein the frame is connected to a roof of a vehicle, wherein the at least two similar air-conditioning system modules each form a condenser unit, wherein the at least two similar air-conditioning system modules are arranged mirror-symmetrically with respect to an axis such that the condenser units are arranged closer to the axis than other parts of the at least two similar air-conditioning system modules. The axis can be, for example, the vehicle center line.

The at least two similar air-conditioning system modules can be formed separately. If the axis is the vehicle center line of a vehicle, the condenser unit of the at least two similar air-conditioning system modules can form two condenser sections, which are aligned longitudinally with respect to the vehicle. The at least two similar air-conditioning system modules can be arranged essentially mirror-symmetrically with respect to the axis, in particular with respect to the vehicle center line. The condenser units of the at least two similar air-conditioning system modules can be arranged adjacent to one another and/or can be arranged so as to abut on one another and/or can be arranged so as to contact one another.

In the case of a further advantageous embodiment of the solution according to the disclosure, it is provided that the first submodule has a condenser or a gas cooler or an external heat exchanger, each including at least one condenser fan, indirect condenser, chiller, electrically driven compressor, water pump and/or electrical coolant heater (in connection with external heat exchanger), and/or that the second submodule has an evaporator including at least one evaporator fan, cabin air filter, heater, heat pump heater, electrical heater, water pump, electrical coolant heater, chiller and/or indirect condenser.

A compressor unit can be attached to and/or arranged at the second submodule. A compressor unit can be installed and/or arranged in the second submodule.

A fan can be provided when a heat exchange with air takes place.

Further important features and advantages of the disclosure follow from the subclaims, from the drawings, and from the corresponding figure description on the basis of the drawings.

It goes without saying that the above-mentioned features and the features, which will be described below, cannot only be used in the respective specified combination, but also in other combination or alone, without leaving the scope of the present disclosure.

### BRIEF DESCRIPTION OF THE DRAWINGS

The disclosure will now be described with reference to the drawings wherein:

FIG. 1 shows a top view onto a modular roof-mounted air-conditioning system, in the case of which several modules are combined to form an assembly wherein each module consists of three submodules,

FIG. 2 shows a top view onto a further exemplary embodiment of a modular roof-mounted air-conditioning system, which is combined to form an assembly,

FIG. 3 shows a top view onto an exemplary embodiment of a modular roof-mounted air-conditioning system including submodules, in the case of which the modules are not combined to form an assembly,

FIG. 4 shows the setup of an air-conditioning system module,

FIG. 5 shows the setup of an air-conditioning system module including submodules,

FIG. 6 shows a front view of a modular roof-mounted air-conditioning system including a frame unit and a hood,

FIG. 7 shows a front view of a further modular roof-mounted air-conditioning system including several module frame units,

FIG. 8 shows an illustration of a modular roof-mounted air-conditioning system including an electrically controlled expansion valve,

FIG. 9 shows a further illustration of a modular roof-mounted air-conditioning system,

FIG. 10 shows a further illustration of a modular roof-mounted air-conditioning system,

FIG. 11 shows a further illustration of a modular roof-mounted air-conditioning system,

FIG. 12 shows a further illustration of a modular roof-mounted air-conditioning system,

FIG. 13 shows a further illustration of a modular roof-mounted air-conditioning system,

FIG. 14 shows a further illustration of a modular roof-mounted air-conditioning system,

FIG. 15 shows a further illustration of a modular roof-mounted air-conditioning system,

FIG. 16 shows a further illustration of a modular roof-mounted air-conditioning system,

FIG. 17 shows a further illustration of a modular roof-mounted air-conditioning system,

FIG. 18 shows a further illustration of a modular roof-mounted air-conditioning system,

FIG. 19 shows a further illustration of a modular roof-mounted air-conditioning system,

FIG. 20 shows a further illustration of a modular roof-mounted air-conditioning system, and

FIG. 21 shows a further illustration of a modular roof-mounted air-conditioning system.

### DESCRIPTION OF EXEMPLARY EMBODIMENTS

Exemplary embodiments of the disclosure will now be described in more detail in the following description, whereby identical reference numerals refer to identical or similar or functionally identical components.

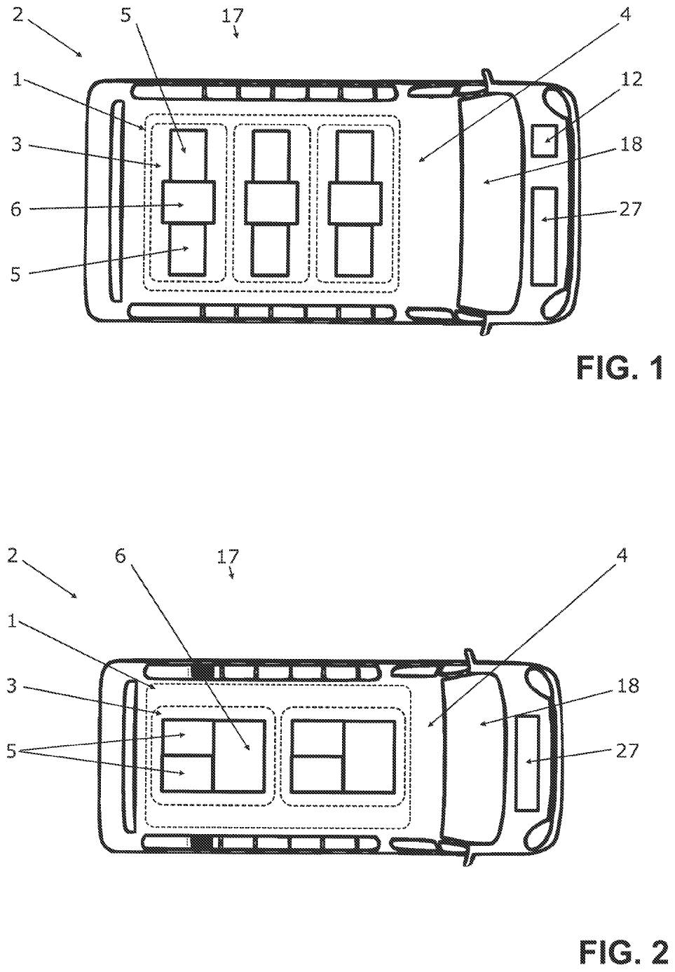

A vehicle 2, which can be formed as large-capacity vehicle for transporting a plurality of persons, is illustrated schematically in FIG. 1, wherein the vehicle 2 is illustrated in a top view, wherein a roof 4 of the vehicle can be seen.

The vehicle 2 has a modular roof-mounted air-conditioning system 1, which is arranged on the roof 4 of the vehicle 2. The modular roof-mounted air-conditioning system 1 ensures a heat exchange between an external environment 17 of the vehicle 2 and a spatial area of the vehicle 2, wherein this spatial area 18 includes in particular a passenger compartment.

The modular roof-mounted air-conditioning system 1 is suggested in FIG. 1 with a dashed border, wherein this border means that the modular roof-mounted air-conditioning system 1 is combined to form an assembly, which cooperates functionally as well as mechanically. This means that the modular roof-mounted air-conditioning system 1 as a whole can be separated from the roof 4, without initially having to remove individual air-conditioning system modules 3 from the roof 4. This does not rule out that the modular roof-mounted air-conditioning system 1 is formed such that only an individual air-conditioning system module 3 can also be removed from the roof 4 of the vehicle 2. This lends itself in particular when only one air-conditioning system module 3 is defective, so that only said defective air-conditioning system module 3 has to be replaced.

The modular roof-mounted air-conditioning system 1 has several air-conditioning system modules 3, which are arranged in the longitudinal direction of the vehicle 2, wherein each air-conditioning system module 3 is constructed similarly, but not necessarily identically. An air-conditioning system module 3 includes, for example, two evaporator units 5, each including at least one evaporator for evaporating a refrigerant. The air-conditioning system module 3 further includes a condenser unit 6 including at least one condenser for liquefying the refrigerant, wherein the condenser unit is arranged between two evaporator units 5, which are spaced apart from one another. If an air-conditioning system module 3 is equipped such that it can also be operated as heat pump, the condenser unit 6 includes an external heat exchanger instead of a condenser, which external heat exchanger operates as condenser or gas cooler during cooling operation, and which operates as evaporator during heating operation. With a chiller, a heat pump can also remove heat from a coolant, which supplies heat from the large variety of components in the bus to the roof-mounted air-conditioning system, and not only ambient heat via the external heat exchanger.

As shown in FIG. 4, the air-conditioning system module 3 can have an evaporator fan 7 and a condenser fan 8, wherein the evaporator fan 7 can be assigned to the evaporator unit 5, and the condenser fan 8 can be assigned to the condenser unit 6. It can be provided that the evaporator unit 5 structurally encompasses the evaporator fan 7, and that the condenser unit 6 structurally encompasses the condenser fan 8.

A common compressor unit 12 of the vehicle 2 is illustrated in FIG. 1, to which each air-conditioning system module 3 can be fluidically connected, wherein a parallel connection of the air-conditioning system modules 3 can be provided here via suitable distribution and return lines. It can also be provided that individual or also each air-conditioning system module 3 can be equipped with a separate compressor unit 9. For the sake of clarity, fluidic connections, electrical connections for the energy supply, as well as suitable communicating connections for controlling the components of the modular roof-mounted air-conditioning system 1 via a non-illustrated control means 33 are not illustrated.

A battery unit 27 is further illustrated in FIG. 1, which can have a non-illustrated cooling circuit. It is conceivable that an air-conditioning system module 3 is fluidically connected to the cooling circuit of the battery unit 27 such that the waste heat generated by the battery unit 27 is transferred via the air-conditioning system module 3 to the external environment 17 of the vehicle 2.

A further vehicle 2 is shown as an example in FIG. 2, which, compared to the vehicle 2 in FIG. 1, is formed to be narrower and slightly shorter, so that the arrangement of the evaporator units 5 and of the condenser unit 6 is designed to be comparatively more compact, whereby the condenser unit 6 is arranged upstream of the two evaporator units 5 in the driving direction of the vehicle. This can also be reversed, for example, i.e., the condenser unit 6 can be arranged downstream in the driving direction. When looking at the vehicle, it is to always be assumed that the vehicle moves in the forward direction, thus would move towards the right page edge of the drawing in FIGS. 1 to 3. In FIG. 2, the air-conditioning system modules 3 are also combined to form an assembly, so that a replacement of the entire modular roof-mounted air-conditioning system 1 is possible.

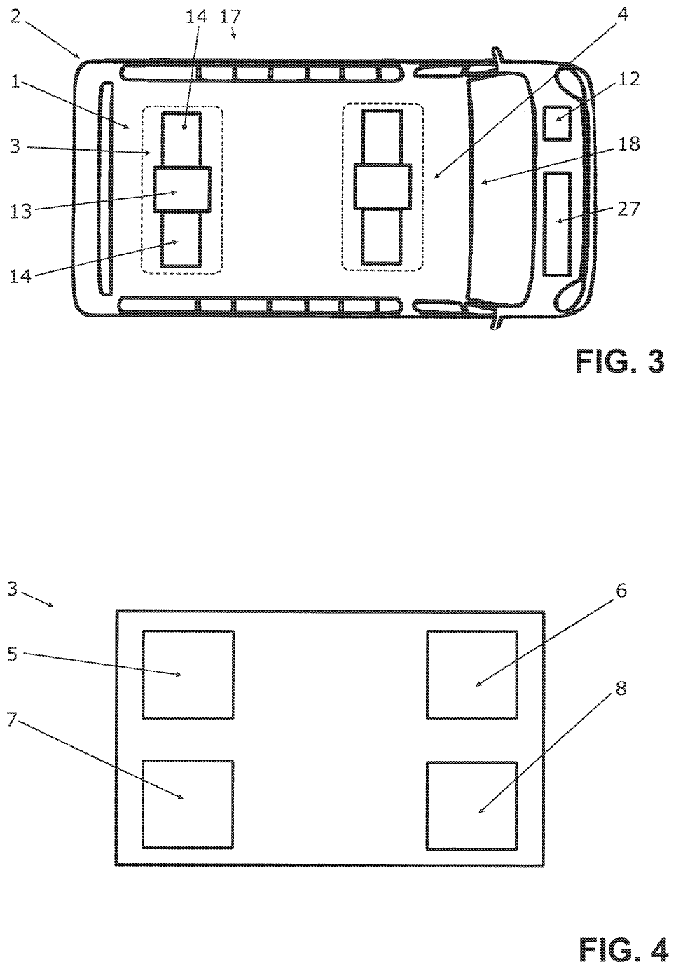

A vehicle including a modular roof-mounted air-conditioning system 1 is shown in FIG. 3, wherein even though the air-conditioning system modules 3 are not combined to form an assembly, the air-conditioning system module 3 has a first submodule 13, which is arranged between two second submodules 14. The second submodules 14 can be similar or also identical.

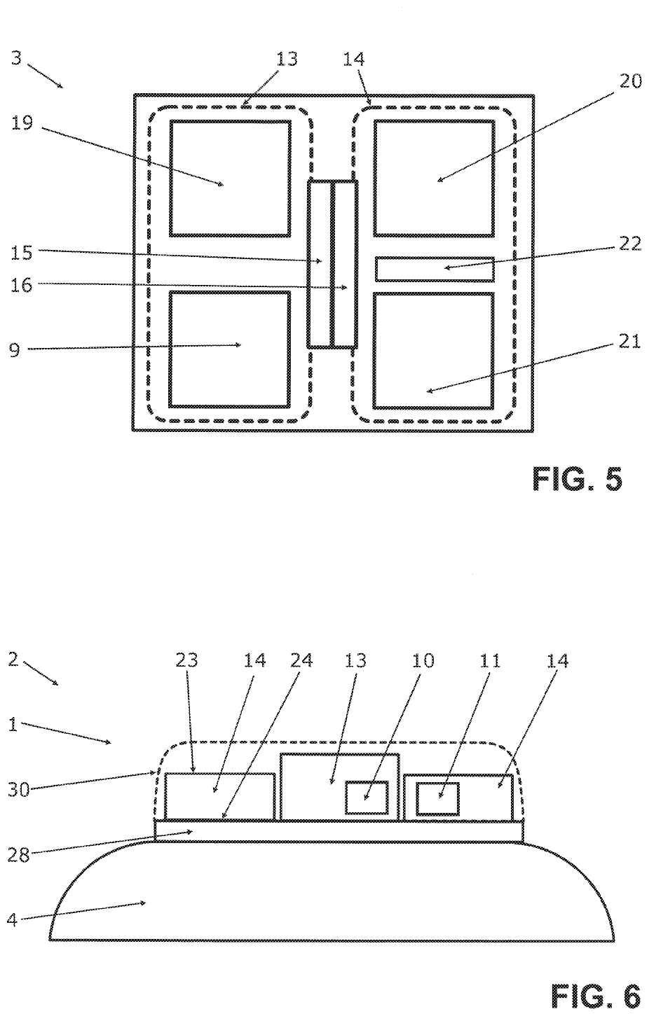

An exemplary setup of an air-conditioning system module 3 is illustrated schematically in FIG. 5, which includes a first submodule 13 and a second submodule 14. The first submodule 13 includes a first connecting section 15, and the second submodule 14 includes a second connecting section 16. The first connecting section 15 and the second connecting section 16 can be designed to be complementary to one another, whereby it can be provided that a releasable connection is provided between the first submodule 13 and the second submodule 14 by plugging together the first connecting section 15 and the second connecting section 16. The first connecting section 15 and the second connecting section 16 can in each case include mechanical and/or fluidic and/or electronic and/or control-related connecting elements, which can be formed to be complementary to one another. A desired air-conditioning system module 3 can be produced thereby with a few work steps and cost-efficiently by a simple coupling of several submodules.

The two submodules 13 and 14 can be placed onto a common frame, wherein the connecting sections 15 and 16 do not form a mechanical holding or supporting function, because they only have pipelines and cables.

Both submodules 13 and 14 can be arranged so as to overlap one another on top of one another and can be connected to one another in the region of the overlap.

As illustrated in FIG. 5, the first submodule 13 includes a first heat exchanger unit 19 and a compressor unit 9. The submodule 14 includes a second heat exchanger unit 20, an air filter unit 22, and a fan unit 21. The first heat exchanger unit 19 is formed to exchange heat energy between the air-conditioning system module 3 and the external environment 17 of the vehicle 2. The second heat exchanger unit 20 is provided for exchanging heat energy between the air-conditioning system module 3 and the spatial area 18, in particular a passenger compartment, of the vehicle 3.

A front view of a modular roof-mounted air-conditioning system 1 is shown in FIG. 6, wherein the roof-mounted air-conditioning system 1 has a first submodule 13, which is arranged between two second submodules 14. The submodules 13 and 14 form an air-conditioning system module 3. The submodule 13 has a chiller unit 10, which can be used to cool a coolant, which is used in a cooling circuit to regulate the temperature of the battery unit 27 of the vehicle 2. A second submodule 14 has a heater unit 11, which can have a heater element for heating the air, which flows into the spatial area 18, in particular a passenger compartment. The chiller unit 10 can also be arranged in the second submodule 14 and/or in an expansion module. In addition to the first and the second submodule, the expansion module can be a part of an air-conditioning system module 3.

A frame unit 28 and/or module frame unit 29, with which the air-conditioning system module 3 formed from the submodules is mounted on the roof, is provided between the modular roof-mounted air-conditioning system 1 and the roof 4 of the vehicle 2. The connection between the submodules and the frame unit 28 as well as the connection between the frame unit 28 and the roof 4 can in each case be formed to be releasable. The modular roof-mounted air-conditioning system 1 has a common housing or a common hood 30, respectively, which covers the air-conditioning system module 3 or the submodules, respectively, and thus protects them against negative atmospheric influences in the described case.

Each submodule has a housing 23, which includes a bottom area 24. The surface area of the housing 23, which is arranged so as to be located nearest to the roof 4, can be considered to be the bottom area 24. The bottom area 24 of the submodules is formed to be planar in FIG. 6. However, the roof 4 of the vehicle 2 can also completely or partially form the bottom area 24.

This can be the case in particular in the case of condenser units. The condenser can be installed in a holding device (part of a housing, which is open towards the bottom) and so as to be located at a distance of, e.g., 10 cm from the roof, so that external air can flow between condenser and roof and can then flow through the condenser from the bottom to the top. A case, i.e., a type of curved hood including a hole, in which an axial fan including a vertical axis can be located, which conveys the air to the top from the condenser, can be located above the condenser. Together, case and holding device can form a housing module for the condenser, the bottom area of which is open or is formed by the roof, respectively.

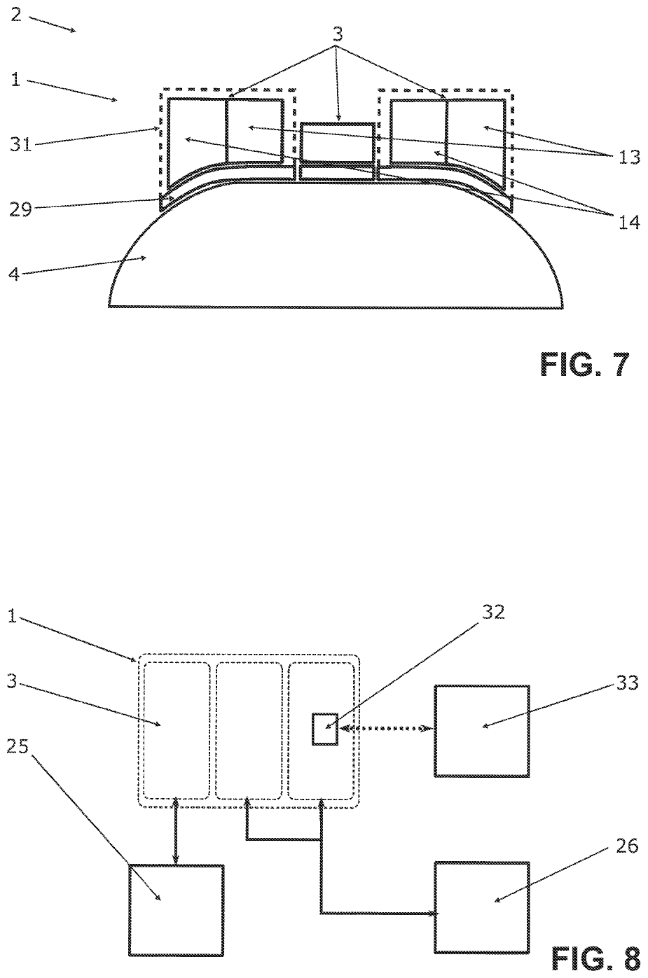

An embodiment alternative of the modular roof-mounted air-conditioning system 1 is shown in FIG. 7, in which the submodules 14 and 13 have bottom areas 24 of different designs. The bottom area 24 of the submodule 14 has a curvature, which is formed to be complementary to the curvature of the area of the roof 4 of the vehicle 2 located opposite thereto. The frame unit 28, which, for example in this embodiment, is formed by the module frame unit 29, can have a complementary design to the geometry of the roof 4 of every vehicle 2. The air resistance of the vehicle 2 can be optimized in spite of the presence of the modular roof-mounted air-conditioning system 1 with a design of this type. A common housing 30 is not provided in FIG. 7, but the external air-conditioning system modules 3 have a separate sub-housing or sub-hood 31, respectively. The air-conditioning system modules 3 can form an essentially similar and/or identical extension length with respect to a vertical direction, starting at the roof 4.

The submodules 14 can be slightly inclined around the longitudinal axis of the vehicle, so that left submodules 14 are inclined to the left, and so that right submodules 14 are inclined to the right, in order to follow the roof contour. The bottom areas of the submodules in FIG. 6 thereby form a polygonal course. The vehicle-specific frame 28 can represent the transition from this polygonal course to the roof curvature.

A modular roof-mounted air-conditioning system 1 is shown in FIG. 8, which is connected to a first subarea 25 of the vehicle 2 via a first fluidic connection. The modular roof-mounted air-conditioning system 1 is further connected to a second subarea 26 of the vehicle 2 via further fluidic connections. The first subarea 25 can include, for example, the refrigerant circuit of a driver air-conditioning system or the coolant circuit of a battery unit 27. The second subarea 26 can include, for example, the spatial rea 18 of a passenger compartment. As illustrated in FIG. 8, only one air-conditioning system module 3 is fluidically connected to the first subarea 25, wherein the two remaining air-conditioning system modules 3 are fluidically connected to the second subarea 26 in parallel. Depending on the cooling capacity demand, the modular roof-mounted air-conditioning system can thereby be partially turned on or turned off. If, for example, a heat exchange is wanted only in the first subarea 25, the two air-conditioning system modules 3, which are connected to the second subarea 26, can be turned off. A more efficient and thus more energy-saving use of the modular roof-mounted air-conditioning system 1 is possible thereby. It is also conceivable that individual spatial areas 18 of the passenger compartment are assigned to individual air-conditioning system modules 3.

As illustrated in FIG. 8, the modular roof-mounted air-conditioning system 1 and/or an air-conditioning system module 3 can have an electrically controllable expansion valve 32 or several electrically controllable expansion valves, e.g., one for each evaporator, wherein the expansion valve 32 is connected in a communicating manner to a control means 33. It can be provided that an expansion valve 32 of this type is assigned to each evaporator unit 5 of the modular roof-mounted air-conditioning system 1, in order to prevent a heating of the evaporator units 5, as it can occur in the case of thermal expansion valves.

Due to the simplified schematic illustration, required fluid lines, refrigerant circuits, electrical supply lines, and control lines are not illustrated for the sake of clarity.

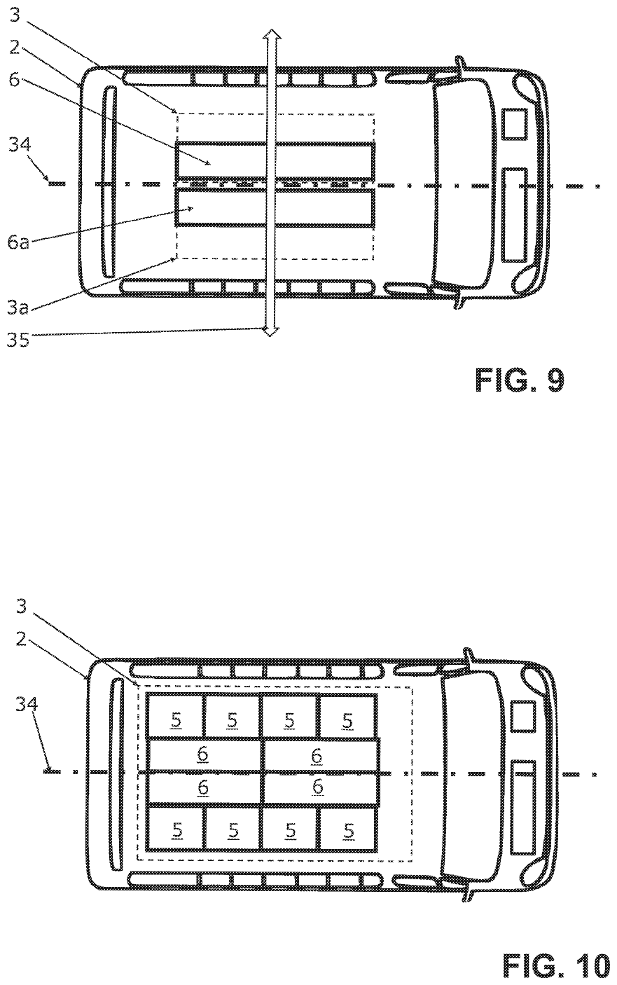

Two similar air-conditioning system modules 3 and 3a are illustrated in FIG. 9, which each form a condenser unit 6 and 6a. With respect to a vehicle center line 34 of the vehicle 2, the air-conditioning system modules 3 and 3a are arranged mirror-symmetrically such that the condenser units 6 and 6a are arranged closer to the vehicle center line 34 than other parts of the at least two similar air-conditioning system modules 3 and 3a. The air-conditioning system modules 3 and 3a each have at least one center line 35, which is aligned transverse and/or perpendicular to the vehicle center line 34.

For the sake of clarity, the vehicle center line 34 is only illustrated in FIG. 9, but applies analogously for all figures.

An air-conditioning system module 3 including eight evaporator units 5 and including four condenser units 6 is illustrated in FIG. 10, wherein the condenser units 6 are arranged closer to the vehicle center line 34 than the evaporator units 5.

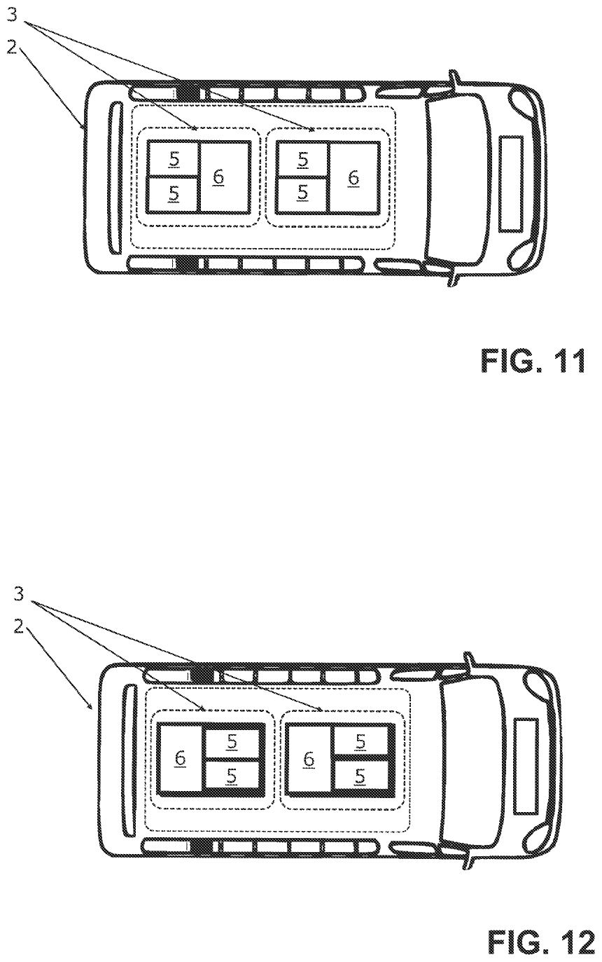

Two similar air-conditioning system modules 3 are illustrated in FIG. 11, which each have two evaporator units 5 and one condenser unit 6. With respect to a forward driving direction of the vehicle 2, the condenser unit 6 is arranged upstream of the two evaporator units 5 within the respective air-conditioning system module 3.

Two similar air-conditioning system modules 3 are illustrated in FIG. 12, which each have two evaporator units 5 and one condenser unit 6. With respect to a forward driving direction of the vehicle 2, the condenser unit 6 is arranged downstream from the two evaporator units 5 within the respective air-conditioning system module 3.

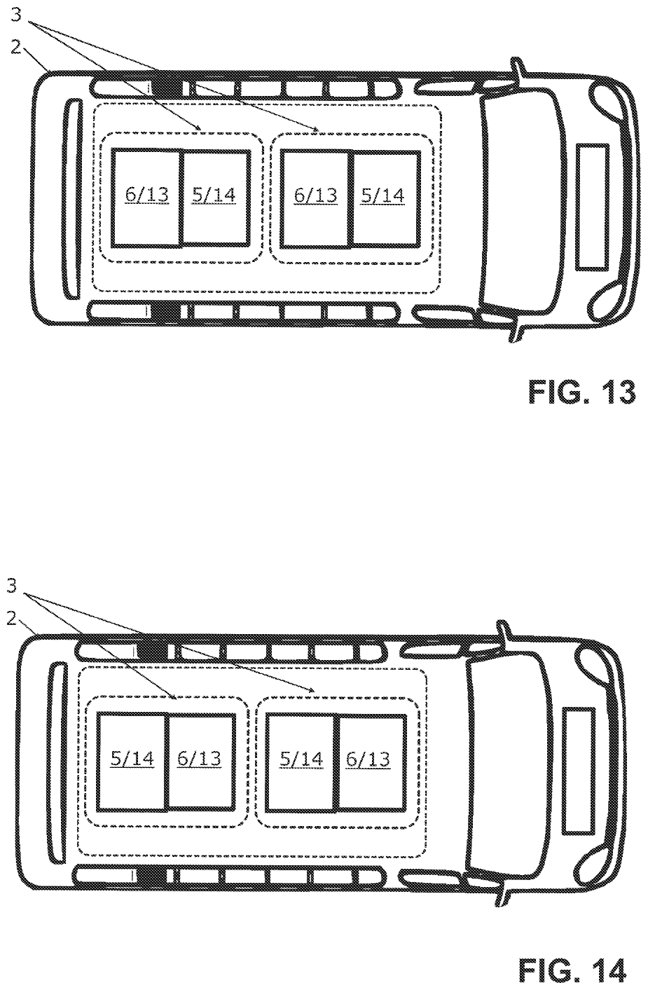

As an example, a first submodule 13 can form or have one condenser unit 6 in FIGS. 13 to 21. As an example, as second submodule 14 can form or have at least one evaporator unit 5 in FIGS. 13 to 21.

Two similar air-conditioning system modules 3 are illustrated in FIG. 13, which each have one evaporator unit 5 and one condenser unit 6. With respect to a forward driving direction of the vehicle 2, the condenser unit 6 is arranged downstream from the evaporator unit 5 within the respective air-conditioning system module 3. The air-conditioning system modules 3 are arranged one behind the other with respect to the vehicle center line 34.

Two similar air-conditioning system modules 3 are illustrated in FIG. 14, which each have one evaporator unit 5 and one condenser unit 6. With respect to a forward driving direction of the vehicle 2, the condenser unit 6 is arranged upstream of the evaporator unit 5 within the respective air-conditioning system module 3. The air-conditioning system modules 3 are arranged one behind the other with respect to the vehicle center line 34.

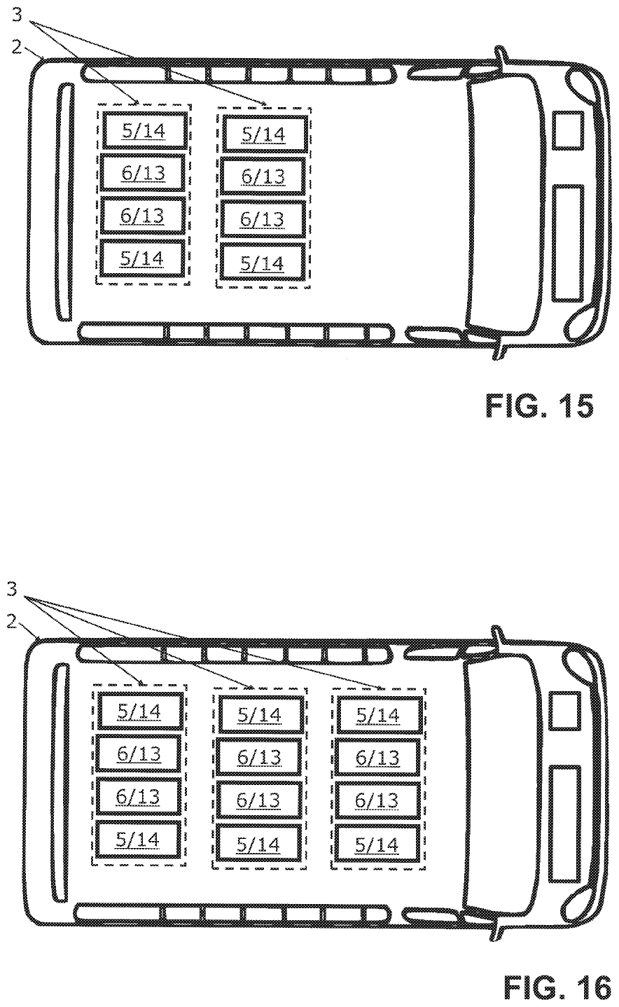

Two similar air-conditioning system modules 3 are illustrated in FIG. 15, which each have two evaporator units 5 and two condenser units 6. The two condenser units 6 are arranged between the two evaporator units 5 in the respective air-conditioning system module 3. The air-conditioning system modules 3 are arranged one behind the other with respect to the vehicle center line 34.

Compared to FIG. 15, three similar air-conditioning system modules 3 are illustrated in FIG. 16, which are arranged one behind the other with respect to the vehicle center line 34.

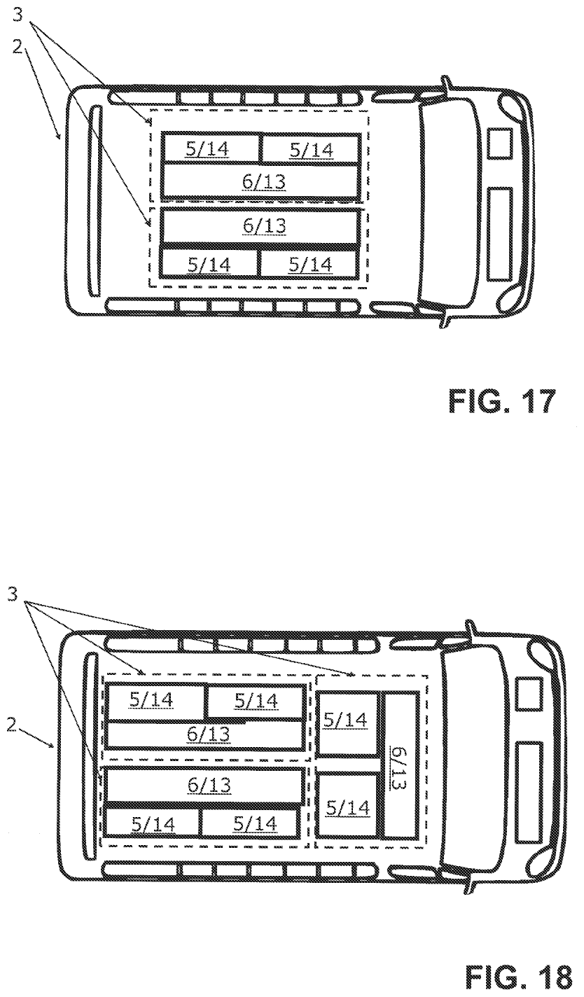

Two similar air-conditioning system modules 3 are illustrated in FIG. 17, which each have two evaporator units 5 and one condenser unit 6. With respect to a vehicle center line 34 of the vehicle 2, the air-conditioning system modules 3 are arranged mirror-symmetrically such that the condenser units 6 are arranged closer to the vehicle center line 34 than the evaporator units 5. The condenser units 6 are arranged between the evaporator units 5.

Compared to FIG. 17, an additional air-conditioning system module 3 is illustrated in FIG. 18, which is arranged upstream of the air-conditioning system modules 3 from FIG. 17 with respect to a forward driving direction of the vehicle 2. The additional air-conditioning system module 3 has two evaporator units 5 and one condenser unit 6, wherein the evaporator units 5 are arranged mirror-symmetrically with respect to the vehicle center line 34 of the vehicle 2.

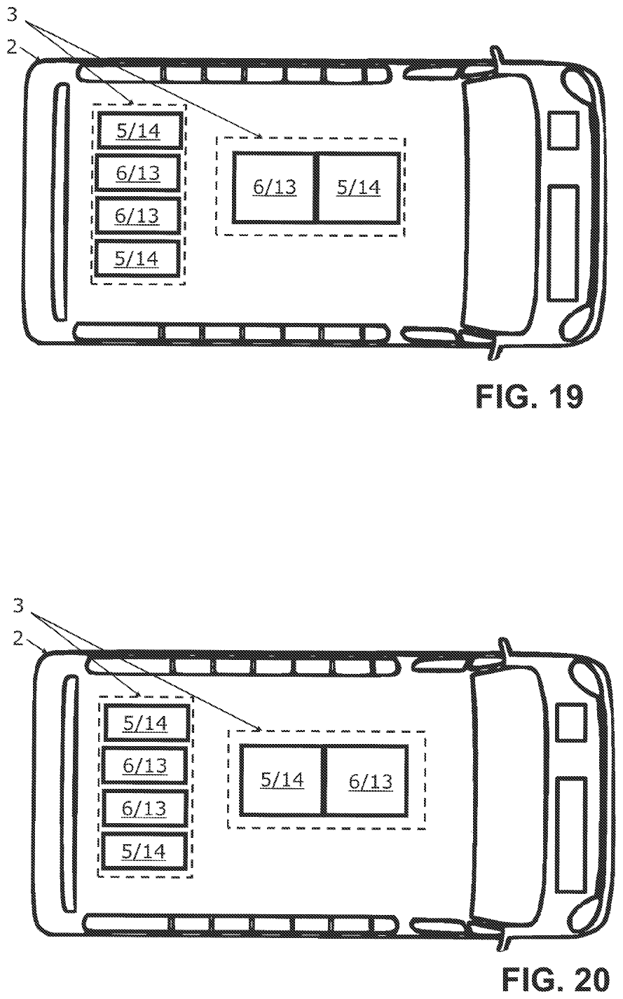

As an example, FIGS. 19 and 20 show further arrangement options of air-conditioning system modules 3.

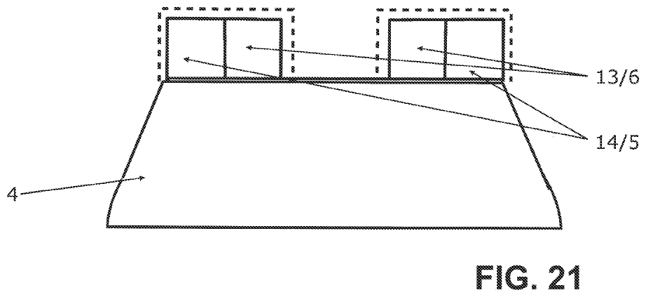

An embodiment alternative of the modular roof-mounted air-conditioning system 1 is shown in FIG. 21, in which the submodules 14 and 13 have bottom areas 24 of similar designs. The second submodules 14 are arranged externally, while the first submodules 13 are arranged internally between the second submodules 14.

It is understood that the foregoing description is that of the exemplary embodiments of the disclosure and that various changes and modifications may be made thereto without departing from the spirit and scope of the disclosure as defined in the appended claims.

What is claimed is:

1. A modular roof-mounted air-conditioning system for a vehicle, the modular roof-mounted air-conditioning system comprising:
at least two similar air-conditioning system modules for air-conditioning spatial areas within the vehicle, and
wherein the air-conditioning system modules are combined to form a functional assembly, wherein the assembly can be installed on a roof of the vehicle.

2. The modular roof-mounted air-conditioning system according to claim 1, wherein at least one air-conditioning system module has at least one evaporator unit, at least one condenser unit, at least one evaporator fan, and at least one condenser fan.

3. The modular roof-mounted air-conditioning system according to claim 1, wherein at least one air-conditioning system module has at least one compressor unit and/or at least one chiller unit and/or at least one heater unit.

4. The modular roof-mounted air-conditioning system according to claim 1, wherein at least two air-conditioning system modules are fluidically connected to at least one common compressor unit.

5. A modular roof-mounted air-conditioning system for a vehicle, the modular roof-mounted air-conditioning system comprising:
at least two similar air-conditioning system modules for air-conditioning spatial areas within the vehicle, and
wherein at least one air-conditioning system module has at least one first submodule and at least one second submodule,
wherein the first submodule has at least one first connecting section,
wherein the second submodule has at least one second connecting section,
wherein the first submodule and the second submodule can be connected via the first connecting section and the second connecting section,
wherein the first submodule is formed for exchanging heat energy between the air-conditioning system module and an external environment of the vehicle, and
wherein the second submodule is formed for exchanging heat energy between the air-conditioning system module and a spatial area, in particular a passenger compartment and/or a driver/front seat area and/or a resting area and/or a refrigerator module and/or a battery unit of the vehicle.

6. The modular roof-mounted air-conditioning system according to claim 5, wherein the first submodule has at least one first heat exchanger unit for exchanging heat energy between the air-conditioning system module and the external environment of the vehicle,
wherein the second submodule has at least one second heat exchanger unit for exchanging heat energy between the air-conditioning system module and the spatial area, in particular a passenger compartment and/or a driver/front seat area and/or a resting area and/or a refrigerator module and/or a battery unit of the vehicle, and
wherein the second submodule has at least one fan unit.

7. The modular roof-mounted air-conditioning system according to claim 5, wherein the first submodule has at least one compressor unit.

8. The modular roof-mounted air-conditioning system according to claim 5, wherein the second submodule has at least one heater unit and/or at least one air filter unit and/or at least one chiller unit.

9. The modular roof-mounted air-conditioning system according to claim 5, wherein a submodule has a housing, and
wherein the design of the housing is formed to be at least partially complementary to the roof area of the vehicle, at which the submodule is arranged.

10. The modular roof-mounted air-conditioning system according to claim 5, wherein at least one first air-conditioning system module air-conditions a first subarea of the vehicle, and
wherein at least one second air-conditioning system module air-conditions a second subarea of the vehicle.

11. The modular roof-mounted air-conditioning system according to claim 10, wherein a subarea of the vehicle comprises a cooling or a temperature-controlling of a battery unit of the vehicle.

12. The modular roof-mounted air-conditioning system according to claim 5, wherein at least one frame unit is arranged between the modular roof-mounted air-conditioning system and the roof of the vehicle.

13. The modular roof-mounted air-conditioning system according to claim 5, wherein at least one modular frame unit is arranged between at least one air-conditioning system module and the roof of the vehicle.

14. The modular roof-mounted air-conditioning system according to claim 5, wherein the modular roof-mounted air-conditioning system has a common housing and/or at least one air-conditioning system module has a sub-housing.

15. The modular roof-mounted air-conditioning system according to claim 5, wherein at least one electrically controllable expansion valve is provided,
wherein the expansion valve is connected in a communicating manner to a control means, and
wherein the control means is set up and/or programmed to control and/or regulate the expansion valve.

16. The modular roof-mounted air-conditioning system according to claim 15, wherein the modular roof-mounted air-conditioning system and/or an air-conditioning system module have an electrically controllable expansion valve or several electrically controllable expansion valves, and/or
wherein an expansion valve of this type is assigned to each evaporator unit of the modular roof-mounted air-conditioning system.

17. The modular roof-mounted air-conditioning system according to claim 5, wherein in the case of at least two air-conditioning system modules, refrigerant-air heat exchangers, in particular all refrigerant-air heat exchangers, are formed as soldered aluminum-microchannel heat exchangers, in particular as flat-tube heat exchangers, and/or
wherein at least one refrigerant-coolant heat exchanger and/or at least one chiller is formed as soldered stacked plate heat exchanger, in particular as soldered all-aluminum stacked plate heat exchanger.

18. The modular roof-mounted air-conditioning system according to claim 5, wherein at least one air-conditioning system module can be mounted on the roof such that a center line of the air-conditioning system module is aligned either perpendicular to the vehicle center line or parallel to the vehicle center line, and/or
wherein every air-conditioning system module has a control means, which are connected in a communicating manner to one another, or that a central control means for all air-conditioning system modules is formed.

19. The modular roof-mounted air-conditioning system according to claim 5, wherein at least two similar air-conditioning system modules are mounted to common frames, and are mechanically connected thereto,
wherein the frame is connected to a roof of a vehicle,
wherein the at least two similar air-conditioning system modules each form a condenser unit,
wherein the at least two similar air-conditioning system modules are arranged mirror-symmetrically with respect to an axis such that the condenser units are arranged closer to the axis than other parts of the at least two similar air-conditioning system modules.

20. The modular roof-mounted air-conditioning system according to claim 5, wherein the first submodule has a condenser or a gas cooler or an external heat exchanger, each comprising at least one condenser fan, indirect condenser, chiller, electrically driven compressor, water pump and/or electrical coolant heater (in connection with external heat exchanger), and/or
wherein the second submodule has an evaporator comprising at least one evaporator fan, cabin air filter, heater, heat pump heater, electrical heater, water pump, electrical coolant heater, chiller and/or indirect condenser.
